(19) United States
(12) Patent Application Publication
(10) Pub. No.: US 2015/0294114 A1
(43) Pub. Date: Oct. 15, 2015

(54) APPLICATION RANDOMIZATION

(71) Applicant: HEWLETT-PACKARD DEVELOPMENT COMPANY, L.P., Houston, TX (US)

(72) Inventors: Brian Quentin Monahan, Bristol (GB); Keith Alexander Harrison, Chepstow (GB)

(21) Appl. No.: 14/432,202

(22) PCT Filed: Sep. 28, 2012
(86) PCT No.: PCT/US2012/057819

§ 371 Date: Mar. 28, 2015

(51) Int. Cl. G06F 21/60; G06F 9/45

(52) U.S. Cl. CPC G06F 21/60; G06F 8/41

(57) ABSTRACT

In one implementation, an application randomization system accesses an annotated intermediate representation of an application, identifies a first instruction block within the annotated intermediate representation, and randomly selects a first modification for the first instruction block. The application randomization system then identifies a second instruction block within the annotated intermediate representation and randomly selects a second modification different from the first modification for the second instruction block. The application randomization system then generates a native-code representation of the application in which the first modification is applied to the first instruction block and the second modification is applied to the second instruction block.

### BACKGROUND

Applications (or software programs) are typically compiled for a particular environment (e.g., operating system and hardware platform) and executed at hosts such as computing systems that realize that environment. Accordingly, one instance of a particular build or version of an application is identical to other instances of that build or version of the application.

Such similarities between instances of an application can be a security risk because an attacker can learn various run-time characteristics about many or all instances of an application by observing one instance of that application. Some environments randomize the address space layout (or memory space footprint) of applications or libraries accessed by applications to vary the locations of application data and executable code to mitigate such security risks.

### BRIEF DESCRIPTION OF THE DRAWINGS

FIG. 1 is an illustration of operation of an application randomization system, according to an implementation.

FIG. 2 is a flowchart of a process to generate an annotated intermediate representation of an application, according to an implementation.

FIG. 3 is an illustration of an annotated intermediate representation of an application, according to an implementation.

FIG. 4 is an illustration of an annotated intermediate representation of an application, according to another implementation.

FIG. 5 is a flowchart of a process to apply random modification to an application, according to an implementation.

FIG. 6 is a flowchart of a random modification process, according to an implementation.

FIG. 7 is a schematic block diagram of an application randomization system, according to an implementation.

FIG. 8 is a schematic block diagram of a computing system hosting an application randomization system, according to an implementation.

### DETAILED DESCRIPTION

Attackers often attempt to learn about the internal operation and structure of an application by interacting with the application. That is, an attacker can learn about an application by providing input to the application and observing output. As a specific example, an attacker can research a web-based or network-enabled application by providing random input and/or targeted input (e.g., input including values or symbols to exploit a particular security vulnerability or class of security vulnerabilities) via an interface of the application, and observing the output of the application. Such techniques can be referred to as fuzzing.

As a specific example, an attacker can provide input that is crafted to exploit a structured query language (SQL) vulnerability (e.g., an SQL query embedded in the input), a buffer overflow vulnerability (e.g., a large volume of data in the input), or an arbitrary code execution vulnerability (e.g., shell code embedded in the input) to an interface of an application. Based on the response or output corresponding to the input, the attacker can determine whether and where within the application a security vulnerability exists.

Attackers also use reverse engineering techniques such as disassembly and assembly code analysis to research applications. For example, an attacker can disassemble a native-code (or object-code) representation of an application and analyze the resulting assembly instructions to learn about the structure and operation of the application.

Because many applications are distributed as copies of a particular build of those applications, a vulnerability in one copy of an application is likely also present in other copies of that application. In other words, each copy of a particular version or build of an application shares the structure, operation, and vulnerabilities of the other copies of that version or build of the application. Accordingly, the information an attacker learns from researching one instance (or executing copy) of the application applies many other instances of that application.

Address space layout randomization (ASLR) has been used to after the memory layout of load-time instances of applications. More specifically, ASLR randomizes the positions or locations in memory of application components such as data, code, libraries, heap, and/or stack. An instance of an application refers to a representation of an application at run-time. For example, an instance of an application can refer to a group of instructions stored at a memory (e.g., Random Access Memory (RAM)) that define the application and are being executed by a processor. ASLR complicates exploitation of some security vulnerabilities because this technique forces attackers to dynamically identify the memory locations of these application components of an executing instance.

ASLR does not, however, change the operation or structure of the application itself. Rather, ASLR moves the in-memory locations of some application components at load-time and/or run-time. Said differently, all the vulnerabilities of one instance of an application exist in other instances of that application, but have merely been relocated in memory. Thus, after an attacker is able to dynamically identify the locations of the vulnerabilities, the vulnerabilities can be consistently exploited.

Implementations discussed herein randomly modify an application before the application is instantiated at a host. Instantiation of an application refers to generating an instance of the application. For example, instantiation can include loading instructions or program code representing the application into a memory (e.g., RAM), and starting execution by a processor at an entry point (e.g., entry address) of the application. In some implementations, instantiation of an application can include repositioning portions of the application within memory to effect ASLR. In other words, implementations discussed herein can be combined with ASLR methodologies.

Random modifications discussed herein can be applied to each instance of the application (i.e., each time the application is instantiated or executed) to alter the structure and operation of the application without altering the functionality of the application. In other words, the random modifications change how the application performs tasks, but do not change what tasks the application performs. Said differently, each instance of the application performs the same functionalities, but does so using different internal structure and/or operation. That is, the results of the different structure and/or operation in each instance are equivalent.

As a result, vulnerabilities are not consistent across instances of the application. Accordingly, research of vulnerabilities in one instance of an application provides little or no insight into vulnerabilities in other instances of the application. Moreover, because the structure and operation of the application is different for each instance, vulnerabilities will not behave consistently across instances of the application. For example, successful code injection in one instance of an application will likely result in abnormal or premature termination of another instance of the application.

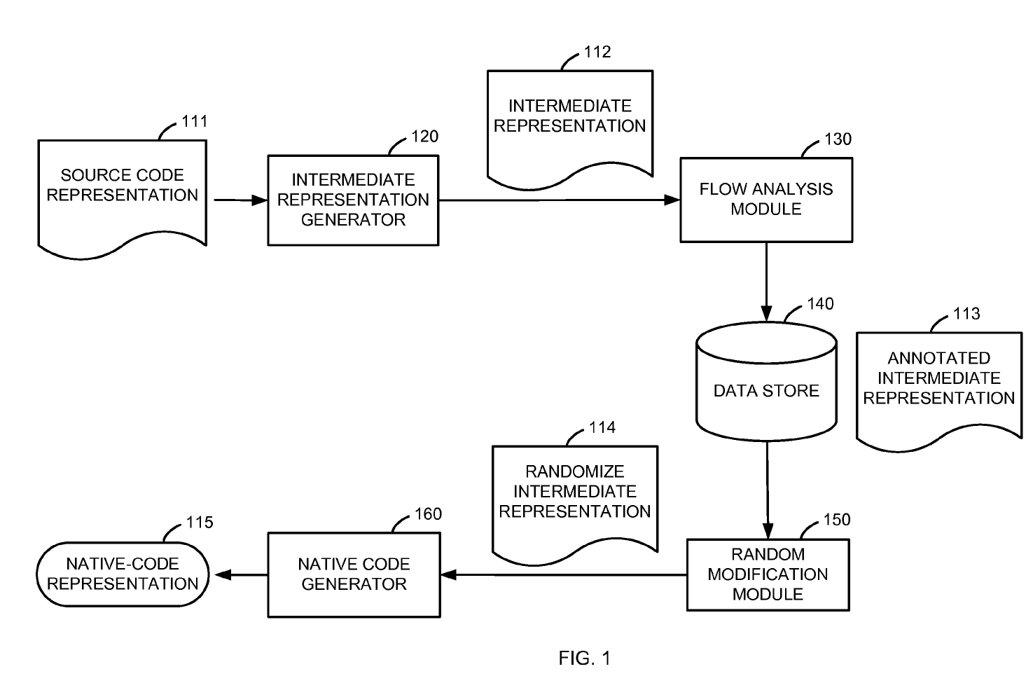

FIG. 1 is an illustration of operation of an application randomization system, according to an implementation. More specifically, FIG. 1 illustrates the flow of an application (or different representations of an application) through components (e.g., modules) of an application randomization system. As used herein, the term “application” refers software that can be executed (or hosted) within an environment to perform one or more functionalities. As examples, a network service such as a web or Hypertext Transfer Protocol server, a web application server, office productivity (e.g., word processing) software, a Portable Document Format (PDF) interpreter, an electronic mail client or server, and middleware such as a network protocol stack are examples of applications.

As illustrated in FIG. 1, source code representation 111 of an application is provided to intermediate representation generator 120. A source code representation of an application is a collection of instructions defined using a human-readable programming language. For example, source code representation 111 can be a file or group of files that define the application in a programming language such as a native programming language. Examples of programming languages include: C, C++, C#, Objective-C, Java™, Haskell, Erlang, Scala, Lua, and Python. In some implementations, source code representation 111 can reference functionalities or resources external to source code representation 111 such as a library or environment service (e.g., operating system service) accessible during compile-time (e.g., at intermediate representation generator 120 or native code generator 160) or at run-time of the application.

Intermediate representation generator 120 is a module that generates an intermediate representation 112 of the application based on source code representation 111. For example, intermediate representation generator 120 can be a compiler or a portion of a compiler such as compiler components to perform lexical, syntactic, semantic, and optimization analysis and to output an intermediate representation of the application. As a specific example of intermediate representation generator 120, intermediate representation 112 can be a Low-Level Virtual Machine (LLVM) bitcode intermediate representation, source code representation 111 can be a group of C source code files, and intermediate representation generator 120 can include an LLVM compiler such as clang that outputs intermediate representation 112. The LLVM intermediate representation can be described in a variety of forms. Typically, the LLVM intermediate representation is described in a bitcode form or a symbolic textual form, and an LLVM system includes utilities for converting between these forms. Thus, implementations discussed herein with reference to an LLVM bitcode intermediate representation are specific example implementations of the invention. The methodologies and systems discussed in relation to such example implementations can be applicable to other implementations such as implementations that utilize other intermediate representations such as LLVM intermediate representations in a symbolic form.

As used herein, the term “intermediate representation” refers to a representation of an application that is specified using an intermediate language, which is a language of a machine other than the host of the application such as an abstract machine. That is, instructions represented in an intermediate representation are not executable directly by the host of the application (i.e., the machine or virtual machine that will execute the application). As examples, intermediate representations can be specified in the Register Transfer Language (RTL), a bytecode language, a static single assignment (SSA) language such as LLVM bitcode, a stack-based intermediate language such as the Common Intermediate Language, some other intermediate language, or a combination thereof.

In some implementations, an intermediate representation of an application is not executable directly by a host of the application. Thus, the intermediate representation is not executed by the host without generating a native-code representation of the application using, for example as discussed in more detail herein, a random modification module and a native code generator. Accordingly, a unique or random native-code representation of the application is generated each time the application is instantiated or executed.

Typically, an intermediate representation simplifies flow analysis of an application. For example, an intermediate representation can represent an application in a form in which each instruction of the intermediate representation define only one operation (i.e., multi-operation instructions do not exist) and the number of registers available is very large or unlimited. As a specific example, an intermediate representation can be a static single assignment form intermediate representation in which each register or variable is assigned once.

Intermediate representation 112 is then accessed by flow analysis module 130 to generate annotated intermediate representation 113. Flow analysis module 130 analyzes intermediate representation 112 to identify instruction blocks within intermediate representation 112. For example, flow analysis module 130 can analyze intermediate representation 112 using data flow and/or control flow analysis techniques to identify instructions blocks within intermediate representation 112. Flow analysis module 130 then annotates intermediate representation 112 to identify instruction blocks and, in some implementations, properties or characteristics thereof within annotated intermediate representation 113.

As used herein, the term “instruction block” means a group of related instructions within an intermediate representation. As a simple example, subroutines within intermediate representation 112 can be defined as instruction blocks. As another example, a group of sequential instructions for which a particular register or value is an operand can be defined as an instruction block. As yet another example, an instruction block can be a group of instructions that are specified sequentially without interruption within an intermediate representation. More specifically, for example, the instructions between jump targets (e.g., instructions to which jump instructions transfer control or execution) and jump (or branch) instructions can be defined as an instruction block. That is, as specified by intermediate representation 112, each instruction in the instruction block is to be executed sequentially. In other words, the control or execution flow of the application proceeds serially through the instructions of an instruction block.

As a specific example, flow analysis module 130 can generate a control flow graph based on intermediate representation 112. Nodes of the control flow graph include (or represent) groups of instructions without any jump instructions or jump targets. That is, a jump target denotes the beginning of a block and a jump instruction denotes the end of a block. The edges of the control flow graph represent jumps (or braches) in the flow of the application. Flow analysis module 130 can then extract or identify the instruction blocks of the application from the nodes of the control flow graph.

Flow analysis module 130 then generates annotated intermediate representation 113 based on intermediate representation 112 and the instructions blocks. That is, flow analysis module 130 annotates intermediate representation 112 to identify the beginning of the instruction blocks to define annotated intermediate representation 113. In some implementations, flow analysis module 130 includes additional annotations (or information) within annotated intermediate representation 113. Such annotations can identify the ends of instruction blocks, identify lengths of instruction blocks, describe of instruction blocks, identify instructions blocks defined by subroutines, identify jump targets to which instruction blocks jump (i.e., the jump target or potential jump targets of a jump instruction at which an instruction block ends), identify the instruction blocks (or jump instructions) that jump to a jump target within an instruction block, and/or include additional information related to instruction blocks.

As illustrated in FIG. 1, annotated intermediate representation 113 can be stored at data store 140. Data store 140 is a device or service such as a hard disk drive (HDD), a non-volatile semiconductor based memory device such as a solid-state drive (SSD), a cache at a volatile memory, a file system, or a database at which annotated intermediate representation 113 can be stored for subsequent use. Such storage can be useful for variety of reasons. For example, the flow analysis performed at flow analysis module 130 can take many seconds, minutes, or even hours for some applications. As will be discussed in more detail herein, annotated intermediate representation 113 can be used to generate a randomized intermediate representation of the application each time the application is instantiated (or launched). Performing flow analysis of intermediate representation 112 for each instantiation of the application can significantly increase the time required to instantiate the application. Thus, accessing pre-generated annotated intermediate representation 130 at data store 140 rather than performing flow analysis can reduce the time required to instantiate the application.

Additionally, because the application typically doesn't change between instantiations of the application (i.e., when no update to the application is available), performing flow analysis for the application using intermediate representation 112 is unnecessarily duplicative. In the event an update to the application is available, flow analysis module 130 can perform flow analysis on an intermediate representation of the updated application, and generate a new annotated intermediate representation to replace annotated intermediate representation 113.

Random modification module 150 accesses annotated intermediate representation 113 at data store 140, for example, in response to an instantiation signal associated with the application. That is, an environment in which the application will be hosted can provide a signal (or indication), for example, in response to user input, that indicates the application should be instantiated to random modification module 150. Random modification module 150 receives annotated intermediate representation 113, and identifies the instruction blocks using the annotations provided by flow analysis module 130. Thus, random modification module 150 need not perform flow analysis for the application. Rather, random modification module 150 relies on the annotations in annotated intermediate representation 113 to provide the results of the flow analysis performed by flow analysis module 130.

Random modification module 150 then randomly modifies the instructions blocks of the application. The modifications performed by random modification module 150 alter the operation and/or structure of the application, but do not alter the functionality of the application. That is, the modifications alter the instruction blocks to, for example, change the number, order, operands, or types, of instructions without altering the results of the instruction blocks.

As examples, random modification module 150 can disaggregate one instruction block into multiple instruction blocks by adding jump instructions (e.g., the jump instructions chain the multiple instruction blocks together to provide equivalent functionality to the one instruction block); rearrange (or reorder) instructions that operate on different data within an instruction block; aggregate two or more instruction blocks by removing jump instructions and adding instructions from one instruction block to another instruction block; add additional instructions to an instruction block; alter an instruction block that is not a subroutine to be a subroutine and jump instructions for which that instruction block is a jump target to be subroutine calls to that instruction block; unroll a loop within an instruction block; combine loops within an instruction block; disaggregate one subroutine into multiple subroutines and add subroutine calls to the subroutines to chain the subroutines together to provide an equivalent result to the one subroutine; inline a subroutine (e.g., add instructions from the subroutine to each instruction block that calls the subroutine); and/or otherwise modify or obfuscate the intermediate representation of the application within annotated intermediate representation 113. Said differently, random modification module 150 can modify the instructions within the intermediate representation of the application within annotated intermediate representation 113 to effect such modifications.

Such modifications are applied randomly to instruction blocks of the application. In other words, for each instruction block of the application, random modification module 150 randomly chooses whether to modify that instruction block and which modification or modifications to apply to that instruction block. As used herein, the terms “random,” “randomly,” and similar terms refer to both true random processes with truly random results and pseudo-random processes such as seed-based pseudo-random number generators. As specific example, a random operation or some operation performed randomly can be based on, for example, a output from a Geiger counter, a photon counter, or a pseudo-random number generator provided with a randomization seed (i.e., a value input an as initial state to the pseudo-random number generator).

In some implementations, the randomization seed can be provided or selected by a user such as a system administrator. For example, an application randomization system can include an interface such as a graphical user interface via which a system administrator can provide a randomization seed. This interface can be secured, for example, using authentication techniques, credentials (e.g., passwords or security certificates), cryptography, trusted computing mechanisms such as Trusted Platform Modules (TPMs), and/or other methodologies.

Such implementations can be useful to allow the system administrator to cause an application randomization system to generate identical native-code representations of an application for, for example, debugging the application and/or the application randomization system. That is, if the modifications are randomly selected based on the output of a pseudo-random number generator, providing the same randomization seed to the pseudo-random number generator causes the pseudo-random number generator to output the same sequence of random inputs (or random values) to a random modification module. Because the random modification module selects modifications for instruction blocks based on the random inputs from the pseudo-random number generator, providing a common randomization seed to the pseudo-random number generator causes the random modification module to select the same modifications for the instruction blocks each time random modification module modifies the intermediate representation of the application.

Random modification module 150 outputs randomized intermediate representation 114. Randomized intermediate representation 114 is an intermediate representation of the application that includes the modifications performed by random modification module 150. Typically, randomized intermediate representation 114 does not include the annotations flow analysis module 130 added to intermediate representation 112 to define annotated intermediate representation 113.

As discussed above, an intermediate representation is not executable by the host (e.g., run-time environment) of the application. Native code generator 160 is a module that accesses randomized intermediate representation 114 and generates native-code representation 115 of the application. Native-code representation 115 of the application is a representation of the application in which the application is defined by instructions that can be executed at the host of the application. For example, native code generator 160 can be a just-in-time compiler or translator to generate native-code representation 115 from randomized intermediate representation 114. Because native-code representation 115 is generated based on (or using or from) randomized intermediate representation 114, native-code representation 115 includes (or has) the modifications performed at random modification module 150. In other words, the modifications performed at random modification module 150 are applied to (or at) native-code representation 115.

As a specific example, randomized intermediate representation 114 can be specified in LLVM bitcode intermediate representation, native code generator 160 can be an LLVM just-in-time compiler for an x86 architecture, and native-code representation 115 can be defined by x86 object or binary code.

In some implementations, native code generator 160 does not perform any optimizations or only performs some types of optimizations on randomized intermediate representation 114 to generate native-code representation 115. For example, native code generator 160 can combine single-operation instructions into multi-operation instructions, but does not remove irrelevant instructions. Such implementations can be particularly beneficial to prevent native code generator 160 from removing or “optimizing out” the random modifications performed by random modification module 150 to generate randomized intermediate representation 114.

In such implementations, intermediate representation generator 120 can perform optimizations on source code representation 111 to generate intermediate representation 112. In some implementations, intermediate representation generator 120 can perform optimizations that native code generator 160 does not perform on source code representation 111 to generate intermediate representation 112. To continue the example from above, intermediate representation generator 120 can perform optimizations to remove irrelevant instructions although native code generator 160 does not. Because intermediate representation generator 120 performs optimizations before random modification module 150 randomly modifies the application, these optimizations do not interfere with the modifications performed by random modification module 150.

In some implementations, a software vendor can use intermediate representation generator 120 and flow analysis module 130 to distribute an application as annotated intermediate representation 113. In other words, rather than distribute a native-code representation of the application, the software vendor can distribute the application as annotated intermediate representation 113. Users of the application can then instantiate the application at a host (e.g., a computing system) with an application randomization system including random modification module 150 and native code generator 160. That is, data store 140, random modification module 150, and native code generator 160 can be accessible to the host. Thus, each time the application is instantiated, a new native-code representation of the application that differs from other native-code representations of the application is generated and executed at the host.

In other implementations, a software vendor can generate a native-code representation of the application for each user or client. That is, data store 140, random modification module 150, and native code generator 160 can be accessible to the software vendor. For example, a potential user of the application can request a native-code representation of the application via, for example, a web page or other interface. The software vendor can then access annotated intermediate representation 113 at data store 140, provide intermediate representation 113 to random modification module 150, and a randomized intermediate representation of the application to native code generator 160. Native code generator 160 then generates the native-code representation of the application for that user, and provides the native-code representation of the application to that user. Thus, each user of the application can have a unique native-code representation of the application.

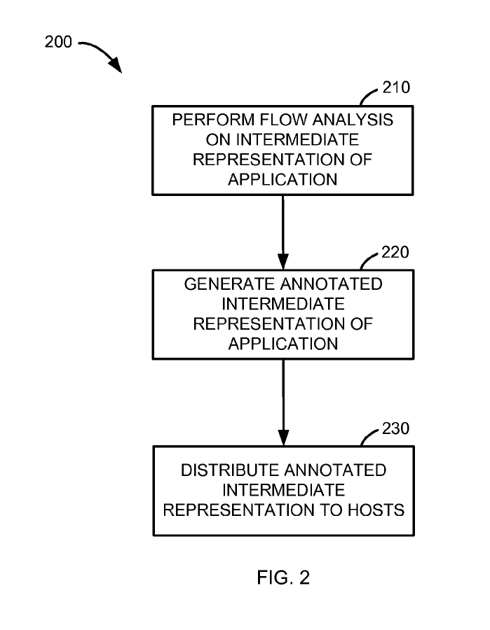

FIG. 2 is a flowchart of a process to generate an annotated intermediate representation of an application, according to an implementation. Process 200 can be implemented, for example, to distribute an application in an annotated intermediate representation to hosts that will execute the application. Flow analysis is performed on an intermediate representation of an application at block 210 to identify instruction blocks within the intermediate representation of the application. For example, a control flow graph or data flow graph can be generated to identify instruction blocks of the application.

Information related to the instruction blocks of the application is then used at block 220 to generate an annotated intermediate representation of the application. The annotated intermediate representation of the application includes the intermediate representation on which flow analysis was performed at block 210, and includes annotations identifying the instruction blocks. In some implementations, the annotations identify, for example, the beginning and end of instructions blocks, instructions blocks defined by subroutines, jump targets to which instruction blocks jump, registers used within an instruction block, and/or other characteristics or properties of instruction blocks.

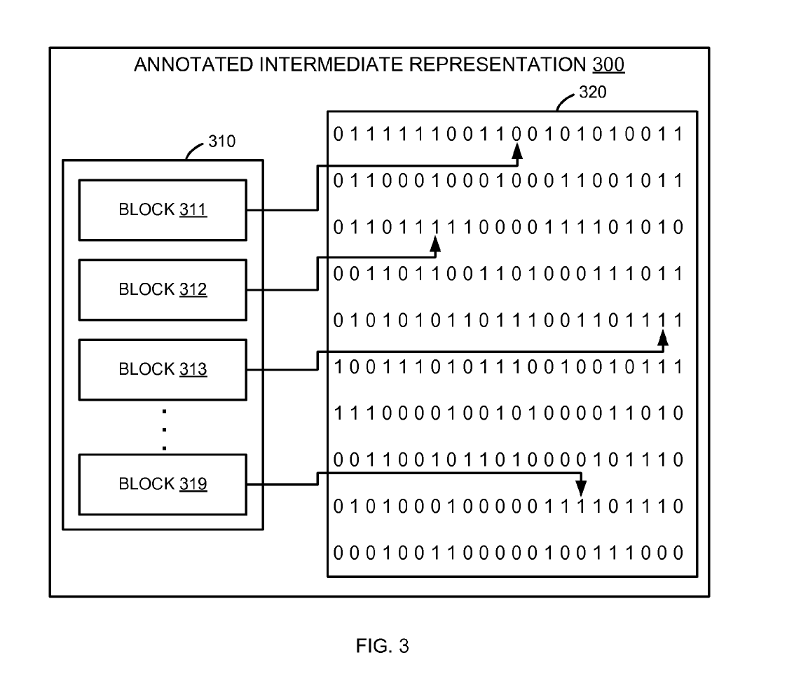

Moreover, an annotated intermediate representation can be in any of a variety of formats. For example, FIG. 3 is an illustration of an annotated intermediate representation of an application, according to an implementation. Annotated intermediate representation 300 includes two sections: section 310 including references to instruction blocks (i.e., annotations identifying instruction blocks), and section 320 including an intermediate representation of an application. Sections 310 and 320 can be, for example, separate files. Section 320 can be a file including an intermediate representation of an application. For example, the intermediate representation can be an LLVM bitcode intermediate representation, and references to blocks 311-319 can be bit or byte offsets into the LLVM bitcode intermediate representation at which instruction blocks are encoded. As another example, sections 310 and 320 can be different portions of a file or data associated with a file. More specifically, for example, section 310 can be metadata at a particular portion of a file (e.g., at the beginning of a file) or metadata stored within a file system and associated with a file including section 320 (i.e., the intermediate representation of the application).

Referring to FIG. 2, at block 220, a byte offset to the beginning of each instruction block within the intermediate representation analyzed at block 210 can be determined, and a value representing that byte offset can be stored at a file or as metadata with an identifier (e.g., a unique number or alpha-numeric identifier) of that instruction block. The identifier, byte offset, and any other information stored at the file or as metadata can be referred to as an annotation.

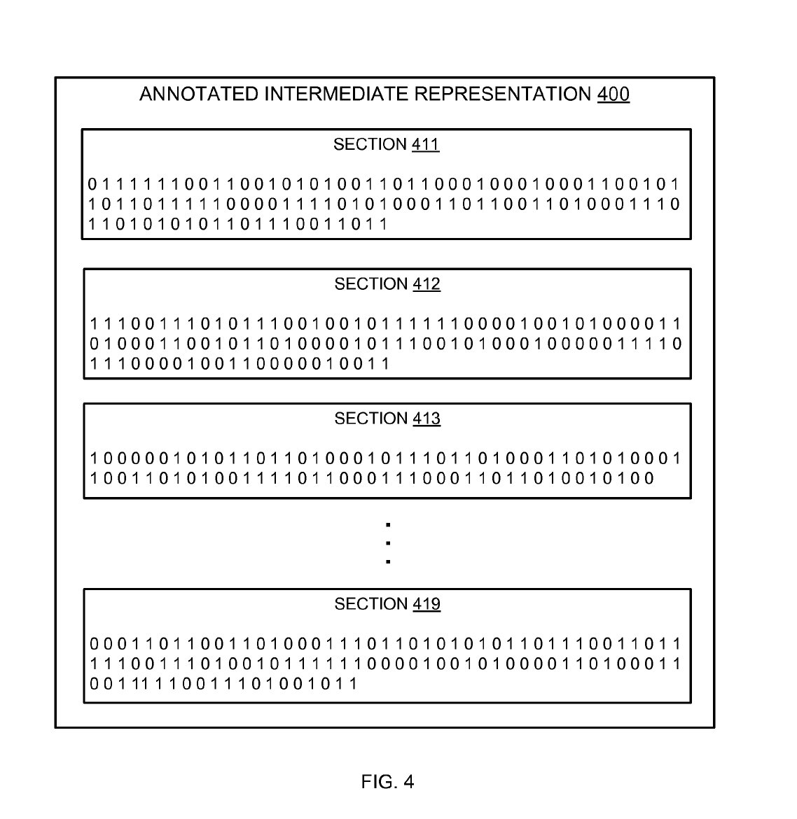

As another example, FIG. 4 is an illustration of an annotated intermediate representation of an application, according to another implementation. Annotated intermediate representation 400 includes multiple sections, each of which includes the intermediate representation of an instruction block. In other words, each of sections 411-419 includes the intermediate representation of an instruction block represented by that section. For example, annotated intermediate representation 400 can be an Extensible Markup Language (XML) document in which each section is an XML element representing an instruction block that encapsulates the intermediate representation of that instruction block.

Referring to FIG. 2, at block 220, an XML document can be generated, and the intermediate representation of each instruction block copied from the intermediate representation of the application into an XML element for that instruction block. Each XML element can also include attributes or other elements to describe the instruction block. For example, such attributes or other elements can include a byte offset of the instruction block, an identifier of the instruction block, jump targets to that instruction block jumps, and/or identifiers of other instruction blocks that jump to that instruction block.

In some implementations, rather than directly manipulating an intermediate representation of an application, the application randomization system can use various tools or utilities to manipulate the intermediate representation. For example, for LLVM intermediate representations, the application randomization system can use tools or utilities of an LLVM system to read, produce, alter, or otherwise manipulate the intermediate representation. Such tools and utilities can include mechanisms for accesses groups of instructions within the intermediate representation as instruction blocks.

At block 230, the annotated intermediate representation of the application can be distributed to hosts. For example, the annotated intermediate representation of the application can be distributed to hosts as downloads via a communications link such as the Internet. Alternatively, for example, annotated intermediate representation of the application can be distributed to hosts on non-transitory processor-readable media such as digital versatile disc (DVDs), FLASH drives, or other media.

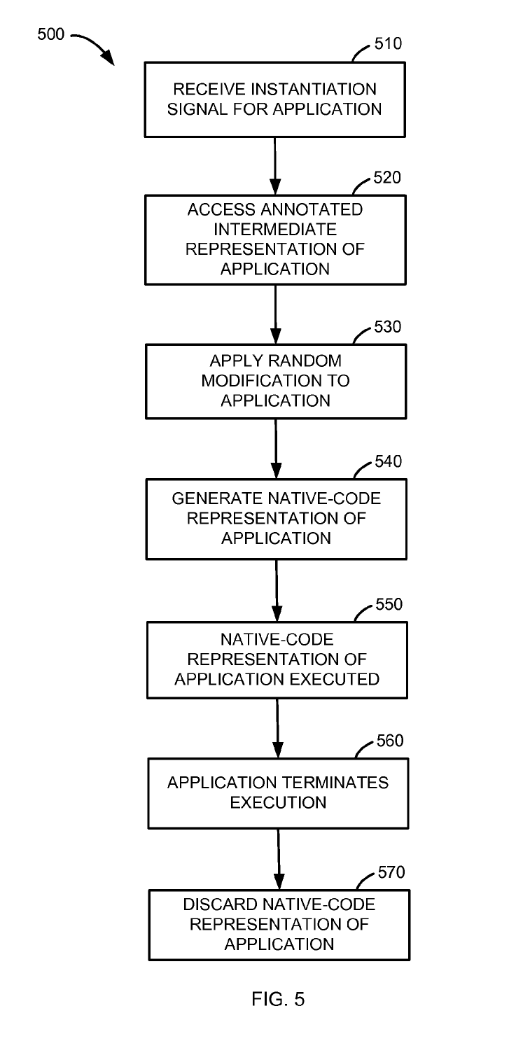

The annotated intermediate representation of the application can then be stored at a data store (or multiple data stores) accessible to each host, and accessed to generate a new native-code representation of the application each time the application is instantiated (or launched). For example, FIG. 5 is a flowchart of a process to apply random modifications to an application, according to an implementation. Process 500 can be implemented at an application randomization system hosted at a host such as a computing device to generate a new native-code representation of an application from an annotated intermediate representation of the application each time the application is instantiated.

At block 510, an instantiation signal such as a load-time instantiation signal for (or associated with) an application is received. For example, an operating system can provide a signal by calling a subroutine or invoking a method of the application randomization system implementing process 500 to indicate that the application should be instantiated. In response to the instantiation signal, the application randomization system accesses an annotated intermediate representation of the application at block 520. For example, the application randomization system can access the annotated intermediate representation of the application at a file system, database, or other data store.

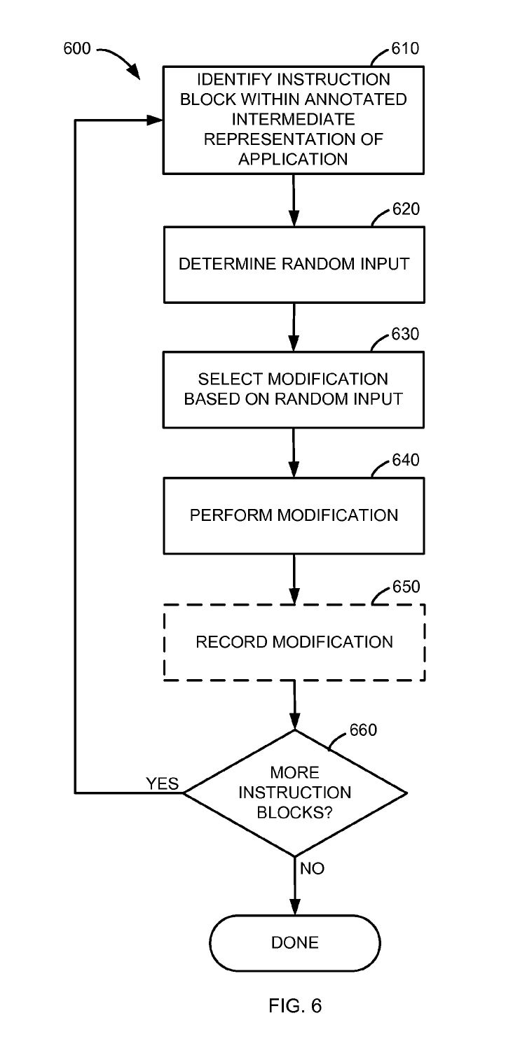

As discussed above, the same annotated intermediate representation of the application is accessed for many instances of the application. However, at block 530, the annotated intermediate representation (or a copy thereof) is randomly modified for each instance of the application. FIG. 6 illustrates an example process to apply random modification to an application, and is discussed in more detail below.

After the annotated intermediate representation is modified at block 530, the randomized intermediate representation of the application is used to generate a native-code representation of the application at block 540. For example, the application randomization system can include or access a compiler such as a just-in-time compiler to convert the randomized intermediate representation to a native-code representation. Moreover, the application randomization system can disable or exclude optimization functionalities of the compiler (e.g., a just-in-time complier) to prevent the compiler from removing the random modifications applied to the randomized intermediate representation at block 540.

The application is then instantiated and the native-code representation of the application executed at block 550 by, for example, loading the native-code representation of the application into a memory of a host and beginning to execute instruction at an entry point of the native-code representation of the application. That instance of the application executes until it terminates or is terminated at block 560, and the native-code representation of the application is discarded at block 570. For example, the native-code representation can be erased from a memory of the host and/or a file storing the native-code representation of the application can be deleted from a file system. In other implementations, the native-code representation of the application is archived at a data store.

As discussed above, process 500 can be executed at the application randomization system for each instantiation signal generated for the application. Thus, each instance of the application is based on a unique native-code representation of the application. As a result, the internal operation and/or structure of each instance of the application differ from other instances of the application.

Process 500 illustrated in FIG, 5 is an example of a process to randomize an application. In other implementations, process 500 can include additional and/or fewer blocks or steps than those illustrated in FIG. 5. For example, in some implementations, process 500 does not include blocks 560 and 570. Moreover, in some implementations, process 500 does not include block 550. Rather, for example, the application randomization system implementing process 500 can store the native-code representation of the application at a data store, and provide a signal to an environment such as an operating system to instantiate the application using the native-code representation.

FIG. 6 is a flowchart of a random modification process, according to an implementation. Process 600 can be, for example, a sub-process of a process to randomize an application such as process 500. As a specific example, process 600 can be executed at block 530 of process 500.

An instruction block is identified within an annotated intermediate representation of an application at block 610. For example, an application randomization system implementing process 600 can parse the annotated intermediate representation to access the annotations and identify the instruction block. For example, as discussed above, an annotation can identify a beginning instruction of the instruction, can encapsulate an intermediate representation of the instruction block, and/or can describe other features or characteristics of an instruction block.

The application randomization system then determines a random input at block 620. The random input can be, for example, a random number or value from a pseudo-random number generator or a random source. The random input is then used to select a modification for the instruction block at block 630. For example, a hash function can be applied to the random input, and the output of the hash function is a value that indicates which of a group of modifications should be applied to the instruction block. More specifically, for example, the value from the hash function can be input to a lookup table to select a modification for the instruction block. Thus, the modification for the instruction block is chosen (or selected) at random.

In some implementations, the application randomization system can vary the amount of modification performed on an application. For example, the application randomization system can include an interface such as a graphical user interface via which a system administrator can specify a level or amount of modification. The application randomization system can weight or bias, for example, a hash function or lookup table (e.g., include multiple entries for a preferred modification or group thereof) toward no modification, a particular group of modifications, or a particular modification based on this input. In other words, in implementations, some modifications can be preferred over (or be more likely than) other modifications.

The modification is then performed on the instruction block at block 640. In other words, the instruction block identified at block 610 is modified according to the modification randomly selected at block 630. That is, for example, instructions are added to, removed from, modified within, or rearranged within the instruction block. In some implementations, other instruction blocks are modified at block 640. For example, other instruction blocks associated with the instruction block identified at block 610 such as instruction blocks that end in a jump to that instruction block (i.e., instruction blocks for which that instruction block is a jump target) or instruction blocks that are jump targets of that instruction block can also be modified at block 640. The modified instruction block is then stored as a randomized intermediate representation of the application at a memory or data store.

The modification or modifications can be, for example, disaggregation of one instruction block into multiple instructions by adding jump instructions, rearrangement of instructions that operate on different data within an instruction block, aggregation of two or more instruction blocks by removing jump instructions and adding instructions from one instruction block to another instruction block, addition of instructions to an instruction block, alteration of an instruction block that is not a subroutine to be a subroutine and jump instructions for which that instruction block is a jump target to be subroutine calls to that instruction block, unrolling a loop within an instruction block, combination of loops within an instruction block, obfuscation, or a combination thereof; some other modification or combination thereof; or a null modification (i.e., no modification).

As illustrated in FIG. 6, in some implementations, the modification is recorded at block 650. For example, a description or identifier of the modification can be recorded at a modification log for later analysis or auditing. In some implementations, recording the modification includes recording a description of the instruction block to which the modification was applied, a representation of that instruction block before the modification, a representation of that instruction block after the modification, and/or other information related to the modification.

Process 600 then proceeds to block 660 to determine whether there are additional instruction blocks within the annotated intermediate representation. If the annotated intermediate representation includes additional instruction blocks, process 600 returns to block 610 at which another instruction block is identified. If the annotated intermediate representation does not include additional instruction blocks, process 600 is complete. In other words, the randomized intermediate representation of the application is complete when all the instruction blocks of the annotated intermediate representation have been processed or considered at blocks 610, 620, 630, 640, and 650.

Process 600 illustrated in FIG. 6 is an example of a process to randomize an application. In other implementations, process 600 can include additional, fewer, and/or rearranged blocks or steps than those illustrated in FIG. 6. For example, in some implementations, process 600 does not include block 650. That is, the application randomization system does not record a modification log. Moreover, in some implementations, process 600 does not include block 650, but includes a block at which a randomization seed used to determine the random input at block 620 is recorded. For example, the random input can be an output of a pseudo-random number generator to which the randomization seed was provided as an initial state. Recording the randomization seed allows, for example, a system administrator to later determine the random inputs used to randomly select the modifications by which the application randomization system randomized the application. Using the random inputs, the system administrator can determine which modifications were performed on which instruction blocks, and reconstruct the randomized intermediate representation of the application based on this information.

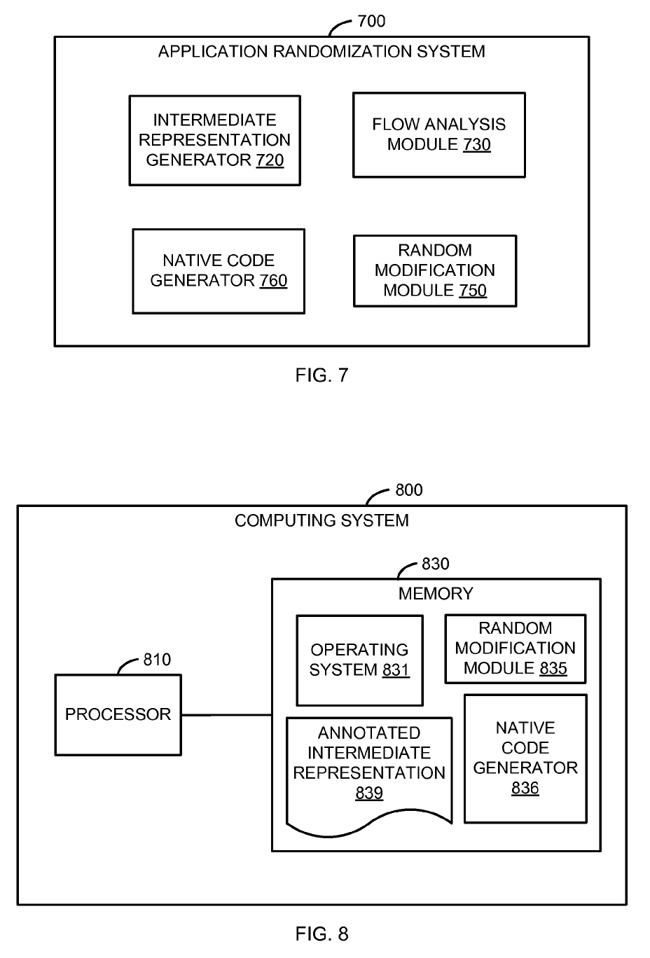

FIG. 7 is a schematic block diagram of an application randomization system, according to an implementation. Application randomization system 700 illustrated in FIG. 7 includes intermediate representation generator 720, flow analysis module 730, random modification module 750, and native code generator 760. Although these particular modules (i.e., combinations of hardware and software) and various other modules are illustrated and discussed in relation to FIG. 7 and other example implementations, other combinations or sub-combinations of modules can be included within other implementations. Said differently, although the modules illustrated in FIG. 7 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

Intermediate representation generator 720, flow analysis module 730, random modification module 750, and native code generator 760 are similar to intermediate representation generator 120, flow analysis module 130, random modification module 150, and native code generator 160, respectively, discussed above in relation to FIG. 1. Intermediate representation generator 720, flow analysis module 730, random modification module 750, and native code generator 760 can be hosted at one host, or can be distributed. For example, intermediate representation generator 720 and flow analysis module 730 can be hosted within an application development environment, and random modification module 750 and native code generator 760 can be hosted at hosts of an application. As a specific example, intermediate representation generator 720 and flow analysis module 730 can be hosted within an application built or compilation system (e.g., a computing system including software to compile a source code representation of an application), and random modification module 750 and native code generator 760 can each be hosted at many computing devices at which instances of an application can be hosted.

In other implementations, random modification module 750 and native code generator 760 can be referred to as an application randomization system. For example, FIG. 8 is a schematic block diagram of a computing system hosting an application randomization system, according to an implementation. In some implementations, a computing system hosting an application randomization system is itself referred to as an application randomization system. In the example illustrated in FIG. 8, computing system 800 includes processor 810 and memory 830. Computing system 800 can be, for example, a personal computer such as a desktop computer or a notebook computer, a tablet device, a smartphone, a television, or some other computing system.

Processor 810 is any combination of hardware and software that executes or interprets instructions, codes, or signals. For example, processor 810 can be a microprocessor, an application-specific integrated circuit (ASIC), a distributed processor such as a cluster or network of processors or computing systems, a multi-core or multi-processor processor, or a virtual or logical processor of a virtual machine.

Memory 830 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 830 can be a volatile random access memory (RAM), a persistent data store such as a hard disk drive or a solid-state drive, a compact disc (CD), a digital versatile disc (DVD), a Secure Digital™ (SD) card, a MultiMediaCard (MMC) card, a CompactFlash™ (CF) card, or a combination thereof or other memories. Said differently, memory 830 can represent multiple processor-readable media. In some implementations, memory 830 can be integrated with processor 810, separate from processor 810, or external to computing system 800.

Memory 830 includes instructions or codes that when executed at processor 810 implement operating system 831, random modification module 835 and native code generator 836. As discussed above, random modification module 835 and native code generator 836 can collectively be referred to as an application randomization system. Also as discussed above, an application randomization system can include additional or fewer modules (or components) than illustrated in FIG. 8.

As illustrated in FIG. 8, memory 830 is operable to store annotated intermediate representation 839. For example, during run-time of operating system 831, annotated intermediate representation 839 can be received via a communications interface (not shown) of computing device 800. As another example, computing system 800 can include (not illustrated in FIG. 8) a processor-readable medium access device (e.g., CD, DVD, SD, MMC, or a CF drive or reader), and can access annotated intermediate representation 839 at a processor-readable medium via that processor-readable medium access device.

In some implementations, computing system 800 can be a virtualized computing system. For example, computing system 800 can be hosted as a virtual machine at a computing server. Moreover, in some implementations, computing system 800 can be a computing appliance or virtualized computing appliance, and operating system 831 is a minimal or just-enough operating system to support (e.g., provide services such as a communications protocol stack and access to components of computing system 800 such as a communications interface) random modification module 835 and native code generator 836.

The application randomization system including random modification module 835 and native code generator 836 can be accessed or installed at computing system 800 from a variety of memories or processor-readable media. For example, computing system 800 can access an application randomization system at a remote processor-readable medium via a communications interface (not shown). As a specific example, computing system 810 can be a network-boot device that accesses operating system 831, random modification module 835 and native code generator 836 during a boot process (or sequence).

As another example, computing system 800 can include (not illustrated in FIG. 8) a processor-readable medium access device (e.g., CD, DVD, SD, MMC, or a CF drive or reader), and can access random modification module 835 and native code generator 836 at a processor-readable medium via that processor-readable medium access device. As a more specific example, the processor-readable medium access device can be a DVD drive at which a DVD including an installation package for one or more of random modification module 835 and native code generator 836 is accessible. The installation package can be executed or interpreted at processor 800 to install one or more of random modification module 835 and native code generator 836 at computing system 800 (e.g., at memory 830). Computing system 800 can then host or execute one or more of random modification module 835 and native code generator 836.

In some implementations, random modification module 835 and native code generator 836 can be accessed at or installed from multiple sources, locations, or resources. For example, some components of random modification module 835 and native code generator 836 can be installed via a communications link (e.g., from a file server accessible via a communication link), and other components of random modification module 835 and native code generator 836 can be installed from a DVD.

In other implementations, random modification module 835 and native code generator 836 can be distributed across multiple computing systems. That is, some components of random modification module 835 and native code generator 836 can be hosted at one computing system and other components of random modification module 835 and native code generator 836 can be hosted at another computing system. As a specific example, random modification module 835 and native code generator 836 can be hosted within a cluster of computing systems where components of each of random modification module 835 and native code generator 836 are hosted at multiple computing systems, and no single computing system hosts all the components of each of random modification module 835 and native code generator 836.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data to a computing system or agent via a communications path or channel), pull mechanisms (e.g., delivering data to a computing system or agent in response to a request from the computing system or agent), and store mechanisms (e.g., storing data at a data store or service at which a computing system or agent can access the data). Furthermore, as used herein, the term “based on” means “based at least in part on.” Thus, a feature that is described as based on some cause, can be based only on the cause, or based on that cause and on one or more other causes.

What is claimed is:

1. A processor-readable medium storing code representing instructions that when executed at a processor cause the processor to:
access an annotated intermediate representation of an application;
identify a first instruction block within the annotated intermediate representation;
randomly select a first modification for the first instruction block;
identify a second instruction block within the annotated intermediate representation;
randomly select a second modification different from the first modification for the second instruction block; and
generate a native-code representation of the application in which the first modification is applied to the first instruction block and the second modification is applied to the second instruction block.

2. The processor-readable medium of claim 1, further comprising code representing instructions that when executed at the processor cause the processor to:
access an intermediate representation of the application;
perform flow analysis on the intermediate representation to identify a plurality of instruction blocks within the intermediate representation, the plurality of instruction blocks including the first instruction block and the second instruction block; and
generate a plurality of annotations associated with the plurality of instruction blocks to define the annotated intermediate representation of the application.

3. The processor-readable medium of claim 1, wherein:
the first instruction block represents a subroutine; and
the first modification includes disaggregating the subroutine into a plurality of subroutines.

4. The processor-readable medium of claim 1, wherein:
the first modification includes rearranging instructions within an intermediate representation of the application; and
the second modification includes adding instructions within the intermediate representation of the application.

5. The processor-readable medium of claim 1, further comprising code representing instructions that when executed at the processor cause the processor to:
record a randomization seed used to randomly select the first modification and to randomly select the second modification.

6. The processor-readable medium of claim 1, further comprising code representing instructions that when executed at the processor cause the processor to:
record the first modification at an modification log; and
record the second modification at the modification log.

7. The processor-readable medium of claim 1, wherein the native-code representation of the application is a first native-code representation of the application and the randomly selecting the first modification and the randomly selecting the second modification are in response to a first instantiation signal, the processor-readable medium further comprising code representing instructions that when executed at the processor cause the processor to:
randomly select, in response to a second instantiation signal, a third modification for the first instruction block, the third modification different from the first modification;
randomly select, in response to a second instantiation signal, a fourth modification different from the second modification for the second instruction block; and
generate a second native-code representation of the application in which the third modification is applied to the first instruction block and the fourth modification is applied to the second instruction block.

8. A processor-readable medium storing code representing instructions that when executed at a processor cause the processor to:
receive a first instantiation signal associated with an application;
identify a plurality of instruction blocks within the annotated intermediate representation of the application;
randomly select, in response to the first instantiation signal, a first modification for each instruction block of the plurality of instruction blocks;
generate a first native-code representation of the application in which the first modification for each instruction block is applied to that instruction block;
receive a second instantiation signal associated with the application randomly select, in response to the second instantiation signal, a second modification for each instruction block of the plurality of instruction blocks;
generate a second native-code representation of the application in which the second modification for each instruction block is applied to that instruction block, the second native-code representation of the application different from the first native-code representation of the application.

9. The processor-readable medium of claim 8, further comprising code representing instructions that when executed at the processor cause the processor to:
record a randomization seed used to randomly select the first modification and the second modification for each instruction block of the plurality of instruction blocks.

10. The processor-readable medium of claim 8, further comprising code representing instructions that when executed at the processor cause the processor to:
record the first modification for each instruction block of the plurality of instruction blocks at an modification log; and
record the second modification for each instruction block of the plurality of instruction blocks at the modification log.

12. The processor-readable medium of claim 8, further comprising code representing instructions that when executed at the processor cause the processor to:
access an intermediate representation of the application;
perform flow analysis on the intermediate representation to identify the plurality of instruction blocks within the intermediate representation; and
generating a plurality of annotations associated with the plurality of instruction blocks to define the annotated intermediate representation of the application.

13. The processor-readable medium of claim 8, further comprising code representing instructions that when executed at the processor cause the processor to:
access a static single assignment form intermediate representation of the application;
perform flow analysis on the intermediate representation to identify the plurality of instruction blocks within the intermediate representation; and
generate a plurality of annotations associated with the plurality of instruction blocks to define the annotated intermediate representation of the application.

14. An application randomization system, comprising:
a random modification module to identify a plurality of instruction blocks within an annotated intermediate representation of an application and to randomly select an modification for each instruction block of the plurality of instruction blocks in response to an instantiation signal associated with the application; and
a native code generator to generate a native-code representation of the application in which the modification for each instruction block is applied to that instruction block.

15. The system of claim 14, further comprising:
a flow analysis module to perform flow analysis on an intermediate representation of the application and to generate the annotated intermediate representation of the application.

16. The system of claim 14, further comprising:
a flow analysis module to perform flow analysis on an intermediate representation of the application and to associating a plurality of annotations with the plurality of instruction blocks to define the annotated intermediate representation of the application.

17. The system of claim 14, wherein the random modification module is configured to record a randomization seed used to randomly select the modification for each instruction block of the plurality of instruction blocks.

18. The system of claim 14, wherein the random modification module is configured to record the modification for each instruction block of the plurality of instruction blocks.

19. The system of claim 14, wherein:
the modification for each instruction block is a first modification for each instruction block;
the instantiation signal is a first instantiation signal;
the native-code representation of the application is a first native-code representation of the application;
the random modification module is configured to randomly select a second modification for each instruction block of the plurality of instruction blocks in response to a second instantiation signal associated with the application; and
the native code generator is configured to generate a second native-code representation of the application in which the second modification for each instruction block is applied to that instruction block.
